(19) United States
(12) Patent Application Publication
(10) Pub. No.: US 2013/0088741 A1
(43) Pub. Date: Apr. 11, 2013

(54) COMMUNICATION SYSTEM, RELAY APPARATUS AND COMMUNICATION APPARATUS

(71) Applicants: Ryohji Murata, Osaka-shi (JP); Atsushi Kurimoto, Osaka-shi (JP)

(72) Inventors: Ryohji Murata, Osaka-shi (JP); Atsushi Kurimoto, Osaka-shi (JP)

(73) Assignee: Sharp Kabushiki Kaisha, Osaka (JP)

(21) Appl. No.: 13/619,431

(22) Filed: Sep. 14, 2012

(30) Foreign Application Priority Data
Oct. 7, 2011 (JP) 2011-223311

(51) Int. Cl. G06F 15/00

(52) U.S. Cl. 358/1.14; 358/1.15

(57) ABSTRACT

In a system including a communication apparatus having a facsimile function and a relay apparatus connected to the communication apparatus via a communication network, a user directly operates the communication apparatus, thereby preventing the communication apparatus from executing inefficient processing in the entire system. The relay apparatus controls the facsimile function of the communication apparatus that has established communication with the relay apparatus to enable transmission and reception of image data. Furthermore, the relay apparatus restricts execution of the facsimile function of the communication apparatus other than facsimile transmission of the image data transferred from the relay apparatus.

### CROSS-REFERENCE TO RELATED APPLICATIONS

This non-provisional application claims priority under 35 U.S.C.§119(a) to Patent Application No. 2011-223311 filed in Japan on Oct. 7, 2011, the entire contents of which is hereby incorporated by reference.

### FIELD

The present invention relates to a communication system including: a plurality of communication apparatuses each having a facsimile function for performing facsimile communication via a telephone network; and a relay apparatus connected to the communication apparatuses via a communication network different from the telephone network, and also relates to a relay apparatus and a communication apparatus.

### BACKGROUND

A facsimile system in which a digital multifunction peripheral having a facsimile function is incorporated into a closed communication network such as a LAN (Local Area Network) or a WAN (Wide Area Network) has been put into widespread use, and furthermore, facsimile server systems with various configurations have been proposed.

For example, Japanese Patent Application Laid-Open No. 6-233040 discloses a facsimile server system in which document data is transmitted from a client apparatus to a facsimile server via a LAN, the facsimile server transmits image data, obtained by expanding the document data, to a remote facsimile apparatus via the LAN, and then the remote facsimile apparatus transmits the image data to a different facsimile apparatus via a public line.

### SUMMARY

However, a conventional facsimile server system such as one disclosed in Japanese Patent Application Laid-Open No. 6-233040 has a problem that the system might be incapable of sufficiently performing its functions depending on user's usage. For example, the conventional facsimile server system is incapable of sufficiently performing its functions when the user operates a digital multifunction peripheral to use a facsimile function of the digital multifunction peripheral that has received the operation, and thus performs facsimile transmission without using the facsimile server.

In such a case, there occurs a problem that when the facsimile server transmits data at a specified time, a telephone network for facsimile transmission might be occupied at the same time, thus making it impossible to perform transmission. Further, there occurs a problem that even when settings are made so that communication fee is reduced by selecting a digital multifunction peripheral having the shortest communication distance from a transmission destination, facsimile transmission is directly performed by a digital multifunction peripheral operated by the user, thus making it impossible to sufficiently reduce communication fee.

The present invention has been made in view of the above circumstances, and its object is to provide: a communication system in which a relay apparatus such as a facsimile server is allowed to restrict execution of a facsimile function of a communication apparatus such as a digital multifunction peripheral which establishes communication with the relay apparatus and is capable of being controlled by the relay apparatus, thereby allowing the system to perform its functions and making it possible to create a highly effective system; a relay apparatus; and a communication apparatus.

A first aspect of the present invention provides a communication system including: a plurality of communication apparatuses each having a facsimile function; and a relay apparatus connected to the communication apparatuses via a communication network different from a telephone network used for facsimile communication, wherein the relay apparatus receives, from one of the communication apparatuses, image data and transmission destination data indicative of a transmission destination for the image data, and transfers the received image data and transmission destination data to a selected communication apparatus based on a predetermined condition, wherein the communication apparatus performs facsimile transmission for transmitting the transferred image data to the transmission destination indicated by the transmission destination data, and wherein the relay apparatus includes restricting means for allowing the communication apparatus, which has established communication with the relay apparatus to enable transmission and reception of image data therebetween, to restrict execution of the facsimile function other than facsimile transmission of the transferred image data.

A second aspect of the present invention provides the communication system, wherein the restriction imposed by the restricting means is disabling of facsimile communication performed by the communication apparatus.

A third aspect of the present invention provides the communication system, wherein the restriction imposed by the restricting means is disabling of facsimile transmission performed by the communication apparatus.

A fourth aspect of the present invention provides the communication system, wherein the restriction imposed by the restricting means allows execution of transmission of image data and transmission destination data to the relay apparatus as an alternative to facsimile transmission performed by the communication apparatus, and wherein the communication system further includes: display means for displaying an operation image; and means for allowing, when the restriction is imposed by the restricting means, the display means to display an operation image that emulates an operation image concerning facsimile transmission performed by the communication apparatus and that is used for execution of transmission of the data to the relay apparatus.

A fifth aspect of the present invention provides the communication system, wherein the communication apparatus further includes means for making a request to the relay apparatus for establishment of communication at startup, and wherein the relay apparatus further includes: means for executing authentication processing for the communication apparatus that has made the request; and means for establishing communication with the communication apparatus, for which authentication is successful, to enable transmission and reception of image data and transmission destination data.

A sixth aspect of the present invention provides the communication system, wherein the communication apparatus further includes means for executing, when authentication by the relay apparatus is unsuccessful and arrival of facsimile communication data is received, reception, storage and printing of image data of the arrived facsimile data.

A seventh aspect of the present invention provides the communication system, wherein the relay apparatus further includes means for allowing, when the selected communication apparatus is a transmission source of image data, the selected communication apparatus to perform facsimile transmission for transmitting the image data to a transmission destination without allowing the selected communication apparatus to transmit the image data to the relay apparatus.

An eighth aspect of the present invention provides a relay apparatus for transferring, upon reception of image data and transmission destination data indicative of a transmission destination for the image data via a communication network, the image data and the transmission destination data to a different apparatus having a facsimile function via the communication network, in order to perform facsimile transmission for transmitting the image data to the transmission destination via a telephone network different from the communication network, wherein the relay apparatus includes means for allowing the different apparatus, which has established communication with the relay apparatus to enable transmission and reception of image data therebetween, to restrict execution of the facsimile function other than facsimile transmission of the transferred image data.

A ninth aspect of the present invention provides a communication apparatus that has a facsimile function and communicates with a different apparatus via a communication network different from a telephone network through which facsimile communication is performed, wherein the communication apparatus includes: means for transmitting, to the different apparatus, image data to be subjected to facsimile transmission and transmission destination data indicative of a transmission destination for the image data; transfer facsimile means for performing, upon reception of image data and transmission destination data from the different apparatus, facsimile transmission for transmitting the received image data to a transmission destination indicated by the transmission destination data; and means for restricting, upon reception of a command for restricting execution of the facsimile function from the different apparatus, execution of the facsimile function other than facsimile transmission performed by the transfer facsimile means.

A tenth aspect of the present invention provides a computer program for causing a computer to transfer, upon reception of image data and transmission destination data indicative of a transmission destination for the image data via a communication network, the image data and the transmission destination data to a different apparatus having a facsimile function via the communication network, in order to perform facsimile transmission for transmitting the image data to the transmission destination via a telephone network different from the communication network, wherein the computer program includes the step of causing the computer to allow the different apparatus, which has established communication with the computer to enable transmission and reception of image data therebetween, to restrict execution of the facsimile function other than facsimile transmission of the transferred image data.

In the present invention, the relay apparatus restricts execution of the facsimile function of the communication apparatus; thus, for example, facsimile transmission made in response to an operation performed on the communication apparatus by a user is inhibited, and the communication apparatus is prevented from executing inefficient processing in the entire system in response to an operation or the like performed by the user. For example, the present invention can prevent occurrence of the problem that when the relay apparatus transmits data at a specified time, the telephone network is occupied at the same time to make it impossible to perform transmission. Further, for example, the present invention can prevent occurrence of the problem that even though the communication apparatus is installed in the vicinity of a transmission destination, the user operates the other communication apparatus installed in an area away from the transmission destination and performs direct facsimile transmission to make it impossible to sufficiently reduce communication fee. Accordingly, the present invention can promote efficient operations in the entire system.

The above and further objects and features of the invention will more fully be apparent from the following detailed description with accompanying drawings.

### BRIEF DESCRIPTION OF THE DRAWINGS

FIG. 1 is an explanatory diagram schematically illustrating an example of a configuration of a communication system according to Embodiment 1 of the present invention.

FIG. 2 is a block diagram illustrating an example of a configuration of a relay apparatus in the communication system according to Embodiment 1 of the present invention.

FIG. 3 is an explanatory diagram schematically illustrating exemplary information recorded in a management information retaining section included in the relay apparatus in the communication system according to Embodiment 1 of the present invention.

FIG. 4 is a block diagram illustrating an example of a configuration of a communication apparatus in the communication system according to Embodiment 1 of the present invention.

FIG. 5 is an explanatory diagram schematically illustrating exemplary information of facsimile function setting flags recorded in a memory included in the communication apparatus in the communication system according to Embodiment 1 of the present invention.

FIG. 6 is an explanatory diagram illustrating an example of an image displayed on an operation unit of the communication apparatus in the communication system according to Embodiment 1 of the present invention.

FIG. 7 is an explanatory diagram illustrating another example of an image displayed on the operation unit of the communication apparatus in the communication system according to Embodiment 1 of the present invention.

FIG. 8 is an explanatory diagram illustrating still another example of an image displayed on the operation unit of the communication apparatus in the communication system according to Embodiment 1 of the present invention.

FIG. 9 is an explanatory diagram illustrating yet another example of an image displayed on the operation unit of the communication apparatus in the communication system according to Embodiment 1 of the present invention.

FIG. 10 is an explanatory diagram illustrating still yet another example of an image displayed on the operation unit of the communication apparatus in the communication system according to Embodiment 1 of the present invention.

FIG. 11 is a flow chart illustrating authentication processing performed by the relay apparatus and communication apparatus in the communication system according to Embodiment 1 of the present invention.

FIG. 12 is a flow chart illustrating exemplary function selection processing performed by the communication apparatus in the communication system according to Embodiment 1 of the present invention.

FIG. 13 is an explanatory diagram illustrating an example of an image displayed on the operation unit of the communication apparatus in the communication system according to Embodiment 1 of the present invention.

FIG. 14 is an explanatory diagram illustrating another example of an image displayed on the operation unit of the communication apparatus in the communication system according to Embodiment 1 of the present invention.

FIG. 15 is a flow chart illustrating exemplary first facsimile transmission processing performed by the relay apparatus and communication apparatus in the communication system according to Embodiment 1 of the present invention.

FIG. 16 is a flow chart illustrating exemplary second facsimile transmission processing performed by the relay apparatus and communication apparatus in the communication system according to Embodiment 1 of the present invention.

FIG. 17 is a flow chart illustrating exemplary first facsimile reception processing performed by the relay apparatus and communication apparatus in the communication system according to Embodiment 1 of the present invention.

FIG. 18 is a flow chart illustrating exemplary second facsimile reception processing performed by the relay apparatus and communication apparatus in the communication system according to Embodiment 1 of the present invention.

FIG. 19 is a flow chart illustrating authentication processing performed by a communication apparatus in a communication system according to Embodiment 2 of the present invention.

FIG. 20 is a flow chart illustrating exemplary first facsimile reception processing performed by the communication apparatus in the communication system according to Embodiment 2 of the present invention.

FIG. 21 is a flow chart illustrating exemplary function selection processing performed by a communication apparatus in a communication system according to Embodiment 3 of the present invention.

FIG. 22 is a flow chart illustrating exemplary third facsimile transmission processing performed by the communication apparatus and relay apparatus in the communication system according to Embodiment 3 of the present invention.

### DETAILED DESCRIPTION OF NON-LIMITING EXAMPLE EMBODIMENTS

Hereinafter, the present invention will be described in detail with reference to the drawings illustrating embodiments thereof.

### Embodiment 1

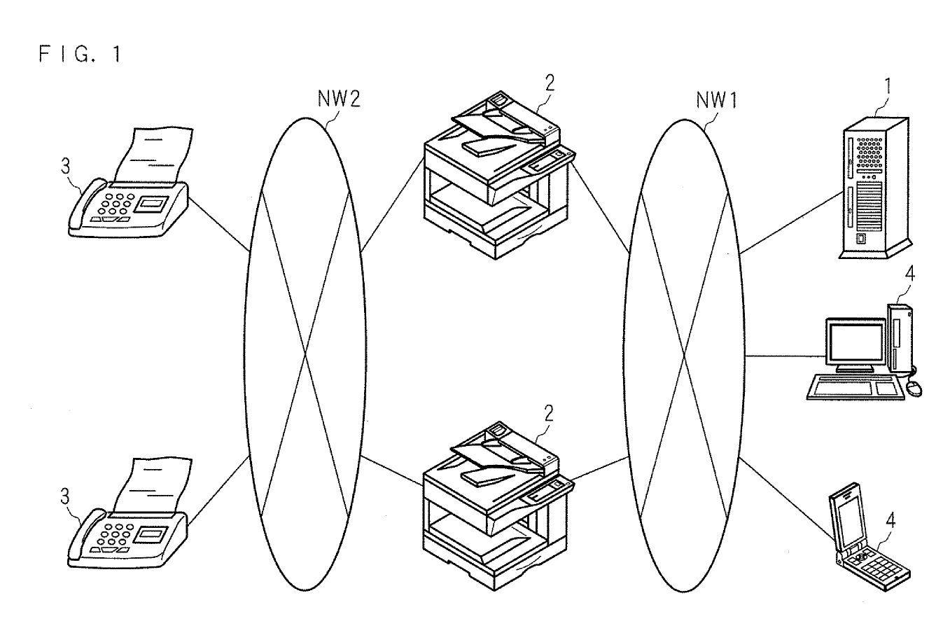

FIG. 1 is an explanatory diagram schematically illustrating an example of a configuration of a communication system according to Embodiment 1 of the present invention. The reference numeral “1” in FIG. 1 denotes a relay apparatus according to the present invention, for which a server apparatus such as a facsimile server apparatus is used. The relay apparatus 1 is connected to a closed communication network NW1 such as a LAN (Local Area Network) or a WAN (Wide Area Network). Note that in the present embodiment, the following description will be made on the assumption that the closed communication network NW1 is used, but any digital communication network may be used as long as it is compliant with a communication protocol such as an IP protocol. For example, various communication networks, such as the Internet, a radio communication network, and a VPN (Virtual Private Network) that utilizes the Internet, may be used.

A plurality of communication apparatuses 2, 2, . . . , for which apparatuses such as digital multifunction peripherals having facsimile functions are used, are connected to the closed communication network NW1. As illustrated in FIG. 1, in the communication system according to the present invention, the communication apparatuses 2, 2, . . . installed at various areas are connected to each other via the closed communication network NW1 such as a WAN, and communicate with the relay apparatus 1 via the closed communication network NW1.

Each of the communication apparatuses 2, 2, . . . is connected to a public telephone network NW2, and has a facsimile function for performing facsimile communication, including facsimile transmission and reception, with other apparatuses such as facsimile apparatuses 3, 3, . . . via the public telephone network NW2.

Further, various terminal devices 4, 4, . . . such as a personal computer, a mobile phone and a smartphone may also be connected with the closed communication network NW1 directly or indirectly.

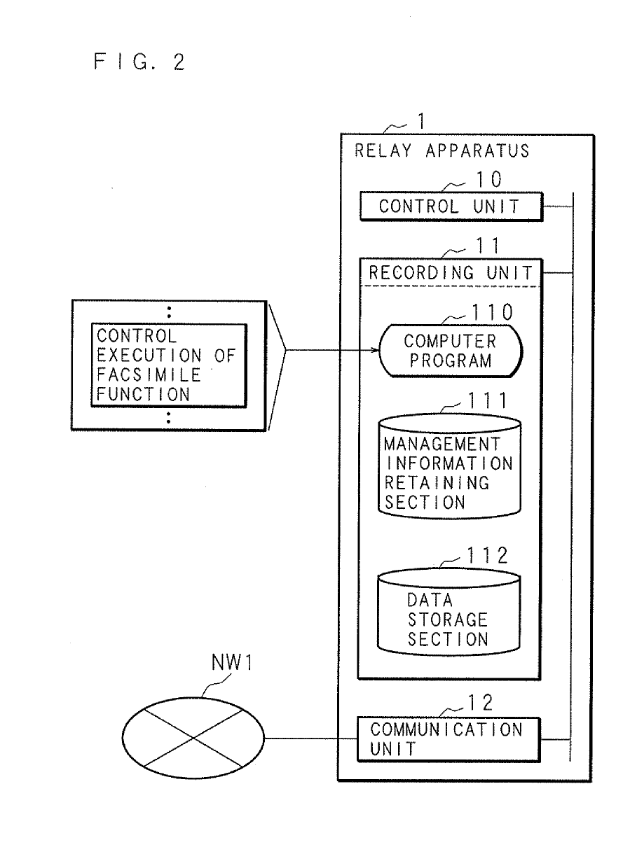

FIG. 2 is a block diagram illustrating an example of a configuration of the relay apparatus 1 in the communication system according to Embodiment 1 of the present invention. The relay apparatus 1 is formed by using a computer selected from various computers, such as a server apparatus utilized as a facsimile server. The relay apparatus 1 includes various units such as: a control unit 10; a recording unit 11; and a communication unit 12.

The control unit 10 is a unit such as a CPU (Central Processing Unit) for controlling the entire apparatus and executing various types of processing described later.

The recording unit 11 means various recording means for recording various pieces of information, and is a unit including a volatile memory for temporarily recording information (e.g., a RAM selected from various RAMs) and/or a nonvolatile memory (e.g., a ROM or a hard disk drive). Furthermore, a different device such as an external hard disk drive, an optical disk drive or a file server connected via a communication network may also be used for the recording unit 11. In other words, the “recording unit 11” used herein is a generic name for one or a plurality of information recording media accessible from the control unit 10.

Note that the recording unit 11 records various programs and various pieces of data such as a computer program 110 according to the present invention, including various steps for allowing a computer such as a server apparatus to be operated as the relay apparatus 1 according to the present invention. The recorded programs, such as the computer program 110 according to the present invention, also include an operation program concerning an operation screen which is described in a page description language such as HTML and provided as a user interface to the communication apparatus 2. The operation program allows the relay apparatus 1 to also function as a Web server on the closed communication network NW1. In addition, various programs for allowing the relay apparatus 1 to function as a facsimile server apparatus are recorded in the recording unit 11.

Further, a recording region of the recording unit 11 is partially used as a database for recording various pieces of information, such as a management information retaining section 111 for recording various pieces of information on the communication apparatuses 2, 2, . . . to be managed by the relay apparatus 1; and a data storage section 112.

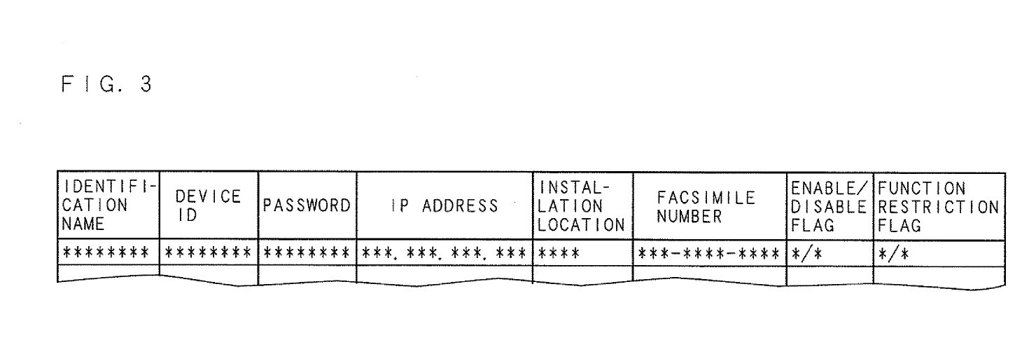

FIG. 3 is an explanatory diagram schematically illustrating exemplary information recorded in the management information retaining section 111 included in the relay apparatus 1 in the communication system according to Embodiment 1 of the present invention. Various pieces of information on the communication apparatuses 2, 2, . . . are recorded in the management information retaining section 111 in a record format so as to be associated with identification names assigned to the communication apparatuses 2, 2, . . . . The various pieces of information include information such as: device IDs; passwords; IP addresses; installation locations; facsimile numbers; enable/disable flags; and function restriction flags. The device IDs and passwords are authentication information set for the respective communication apparatuses 2, 2, . . . . The IP addresses are identification information identifying positions of the communication apparatuses 2, 2, . . . on the closed communication network NW1. The installation locations are information on business facilities, areas or the like where the communication apparatuses 2, 2, . . . are installed. Note that information such as area codes and local exchange numbers of the facsimile numbers may be used as information indicative of the installation locations. The enable/disable flags are flag format information indicative of whether or not the respective communication apparatuses 2, 2, . . . are under the management of the relay apparatus 1 and usable. The function restriction flags are information concerning function restriction set for the respective communication apparatuses 2, 2, . . . , so that information indicative of settings for enabling/disabling facsimile transmission/reception, for example, is recorded in a flag format. The relay apparatus 1 restricts execution of the facsimile function of the communication apparatus 2 based on the information recorded in the management information retaining section 111.

Referring again to FIG. 2, the data storage section 112 is a database for storing data such as image data and transmission destination data indicative of a transmission destination for the image data, which are received from the communication apparatus 2. The control unit 10 is capable of making access to various databases such as the management information retaining section 111 and the data storage section 112 when necessary.

The communication unit 12 is a network interface connected to the closed communication network NW1, and includes a LAN port and various circuits such as accessory circuits thereof.

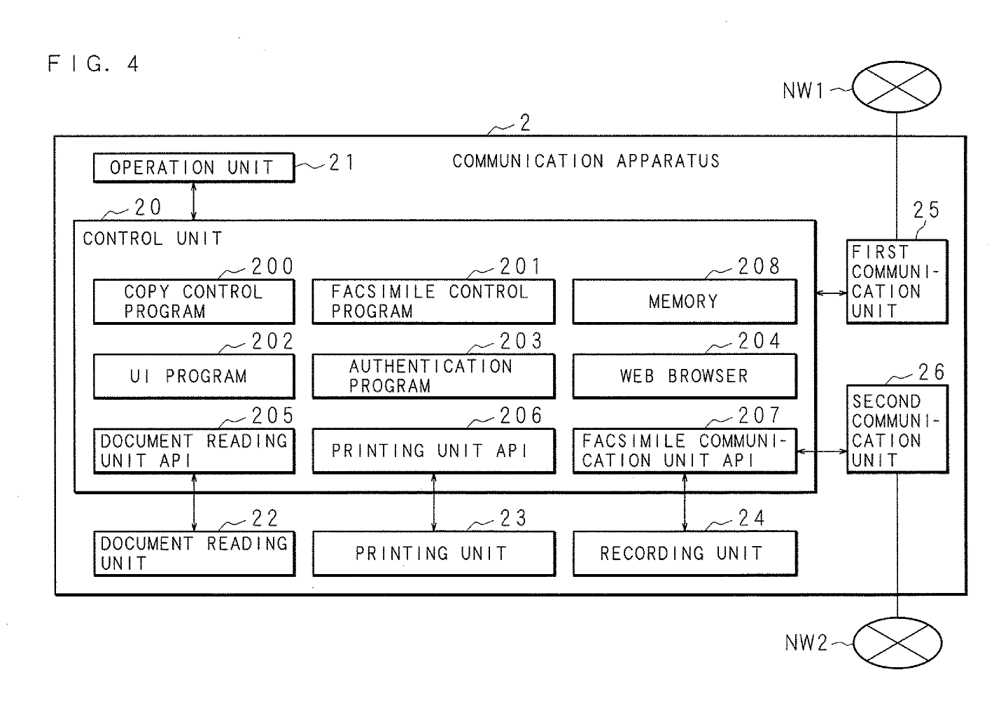

FIG. 4 is a block diagram illustrating an example of a configuration of the communication apparatus 2 in the communication system according to Embodiment 1 of the present invention. The communication apparatus 2 includes various units such as: a control unit 20; an operation unit 21; a document reading unit 22; a printing unit 23; a recording unit 24; a first communication unit 25; and a second communication unit 26. Note that the following description will be centered on various functions for implementing the facsimile function; however, when the communication apparatus 2 is formed by using a digital multifunction peripheral, the communication apparatus 2 is provided with various functions such as a copy function and a printer function, in addition to the facsimile function.

The control unit 20 is a unit such as a CPU for controlling the entire apparatus, and operates various modules implemented as hardware or software. Note that the various modules will be described later.

The operation unit 21 is a unit including: a push button for receiving an operation performed by a user; a user interface such as a touch panel; and various circuits and programs for passing information, which is based on the received operation, to the control unit 20. For instance, the user operates the operation unit 21, thereby making it possible to input, for example, transmission destination data such as the facsimile number of a transmission destination, a facsimile transmission operation, and various settings concerning transmission.

The document reading unit 22 is a unit including various circuits and programs for generating image data by scanning a medium to be scanned, such as a sheet on which an image to be transmitted is presented.

The printing unit 23 is a unit including various circuits and programs for forming, on an image formation medium such as a copy paper, an image to be outputted by various functions such as the facsimile function, copy function and printer function.

The recording unit 24 is a unit formed by using a recording medium such as a hard disk for recording image data in addition to various pieces of information.

The first communication unit 25 is a network interface connected to the closed communication network NW1, and includes a LAN port and various circuits such as accessory circuits thereof.

The second communication unit 26 is a communication interface connected to the public telephone network NW2, and includes a telephone line port and various circuits such as accessory circuits thereof.

Next, the various modules included in the control unit 20 will be described. The control unit 20 includes the various modules such as: a copy control program 200; a facsimile control program 201; a UI program 202; an authentication program 203; a Web browser 204; a document reading unit API 205; a printing unit API 206; and a facsimile communication unit API 207.

The copy control program 200 is a control program for executing a function concerning copying.

The facsimile control program 201 is a control program for executing a function concerning facsimile communication such as facsimile transmission and facsimile reception.

The UI program 202 is a control program concerning: various screens to be displayed on the operation unit 21; and a user interface for carrying out control based on various inputs received from the operation unit 21.

The authentication program 203 is a program for making access to the relay apparatus 1 to issue a request for authentication to the relay apparatus 1.

The Web browser 204 is a program for allowing the operation screen, described in a page description language such as HTML, to be displayed on the operation unit 21 in such a manner that the operation screen can be browsed by the user.

The document reading unit API 205 is a control program for controlling the document reading unit 22. For example, suppose that from an external apparatus such as the relay apparatus 1, the communication apparatus 2 has received: setting data indicative of a read condition; transmission destination data or storage destination data indicative of a transmission destination or storage destination for image data which is based on a read document; and a reading command. In that case, the document reading unit API 205 carries out control for allowing the document reading unit 22 to read a document in accordance with the reading condition based on the setting data, thereby allowing the image data, which is based on the read document, to be transmitted to the transmission destination based on the transmission destination data or allowing the image data to be stored at the storage destination based on the storage destination data.

The printing unit API 206 is a control program for controlling the printing unit 23. For example, suppose that from an external apparatus such as the relay apparatus 1, the communication apparatus 2 has received: setting data indicative of a printing condition such as a sheet size or a discharge tray; image data to be printed; and a printing command. In that case, the printing unit API 206 controls, in accordance with the printing condition based on the setting data, the printing unit 23 so that an image, which is based on the image data, is formed on an image formation medium.

The facsimile communication unit API 207 is a control program for controlling the second communication unit 26 to execute the facsimile function. For example, suppose that from the relay apparatus 1, the communication apparatus 2 has received: setting data indicative of a facsimile transmission condition such as a resolution or a transmission destination; image data to be subjected to facsimile transmission; and a transmission command. In that case, the facsimile communication unit API 207 controls the second communication unit 26 to transmit the image data in accordance with the facsimile transmission condition based on the setting data. Furthermore, for example, upon reception of a transfer command from the relay apparatus 1, the facsimile communication unit API 207 controls the second communication unit 26 so that the image data and transmission destination data, recorded in the recording unit 24, are transmitted to the relay apparatus 1.

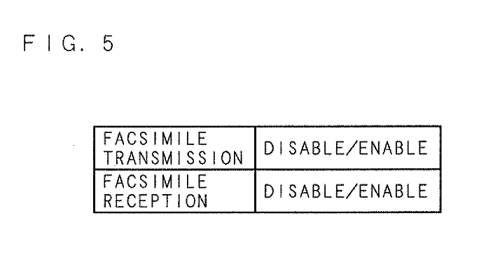

Moreover, the control unit 20 has a memory 208 such as a flash memory for recording various pieces of information. In the memory 208, information such as facsimile function setting flags is recorded. FIG. 5 is an explanatory diagram schematically illustrating exemplary information of the facsimile function setting flags recorded in the memory 208 included in the communication apparatus 2 in the communication system according to Embodiment 1 of the present invention. The facsimile function setting flags illustrated in FIG. 5 indicate that flags for enabling/disabling facsimile transmission and facsimile reception are set. Under the control of the relay apparatus 1, settings are made so that facsimile transmission and facsimile reception are disabled or enabled.

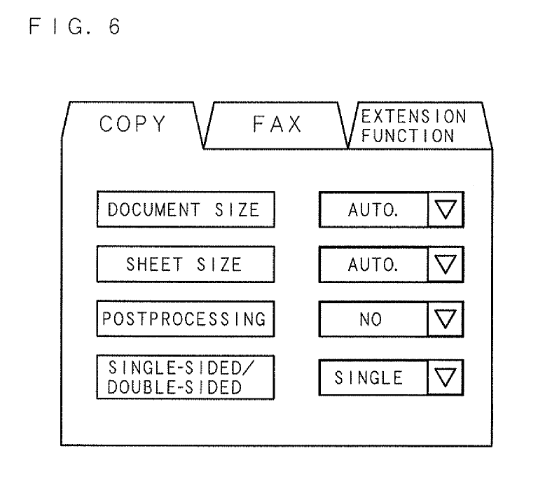

Next, the user interface of the communication apparatus 2 will be described. FIGS. 6 to 10 are explanatory diagrams illustrating examples of images displayed on the operation unit 21 of the communication apparatus 2 in the communication system according to Embodiment 1 of the present invention. FIGS. 6 to 10 each illustrate an example of an operation image displayed on the touch panel of the operation unit 21 in a situation where the facsimile function is not restricted by the relay apparatus 1.

The operation image allows selection of a function to be operated, with the use of tabs representing “Copy”, “FAX” and “Extension Function”. FIG. 6 illustrates the image displayed upon selection of the tab representing “Copy”, and this image serves as the operation image when the copy function is utilized by the user. As illustrated in FIG. 6, the user can make settings for “Document Size”, “Sheet Size”, “Postprocessing” and “Single-Sided/Double-Sided” by operating the operation unit 21.

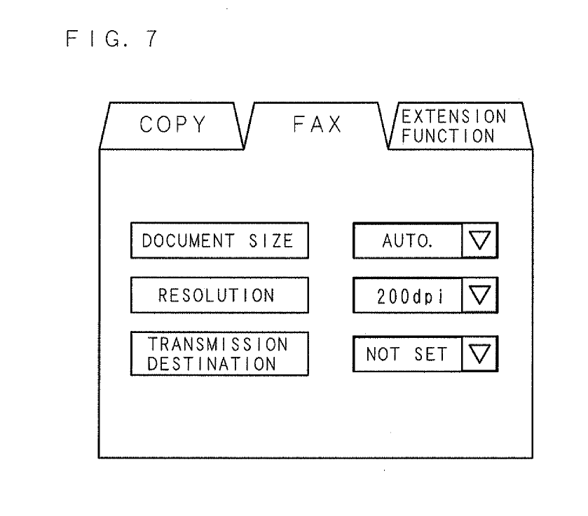

FIG. 7 illustrates the image displayed upon selection of the tab representing “FAX”, and this image serves as the operation image when the facsimile function is utilized by the user. As illustrated in FIG. 7, the user can make settings for “Document Size”, “Resolution” and “Transmission Destination” by operating the operation unit 21.

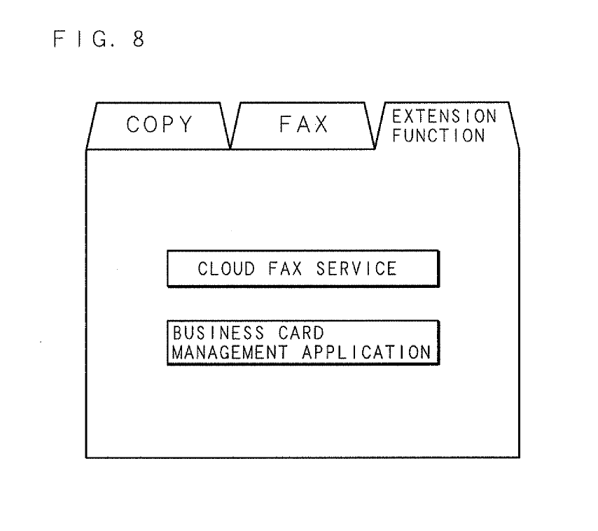

FIG. 8 illustrates the image displayed upon selection of the tab representing “Extension Function”, and this image serves as the operation image when various extension functions are utilized by the user. As illustrated in FIG. 8, the user can select and execute “Cloud Fax Service” or “Business Card Management Application” as the extension function by operating the operation unit 21. “Cloud Fax Service” refers to a network facsimile function for executing the facsimile function under the management of the relay apparatus 1.

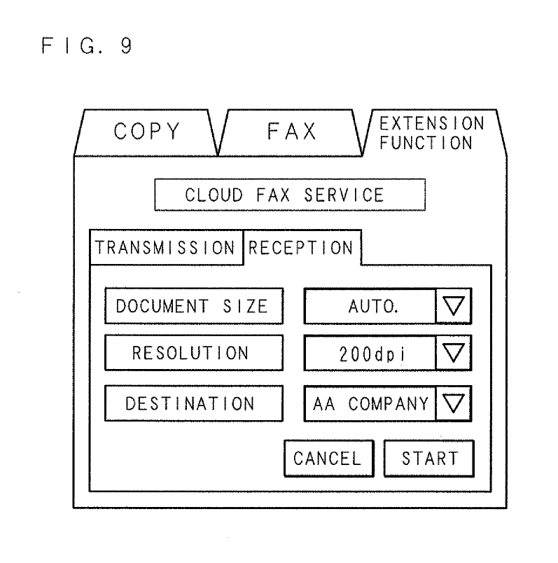

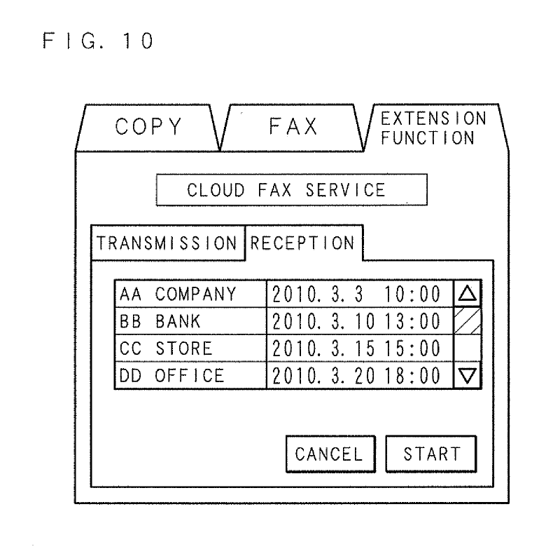

FIGS. 9 and 10 illustrate images displayed upon selection of “Cloud Fax Service” in the state illustrated in FIG. 8, and the images serve as the operation images when “Cloud Fax Service” is utilized by the user.

FIG. 9 illustrates the operation image displayed when the user makes settings for facsimile transmission. In this case, the user can make settings for “Document Size”, “Resolution” and “Destination (Transmission Destination)”.

FIG. 10 illustrates the operation image displayed when the user acquires image data obtained by facsimile reception. In this case, the user can select and acquire desired image data from reception history.

The communication system according to the present invention manages the communication apparatus 2 so that execution of the facsimile function for direct facsimile transmission from the second communication unit 26 is restricted when the above-described various functions are executed, and the network facsimile function is preferentially utilized when facsimile communication is necessary. Further, the communication system manages the communication apparatus 2 so that upon reception of facsimile data, execution of the facsimile function for directly printing an image based on the received facsimile data is restricted, and the facsimile data is transferred, as image data, to the relay apparatus 1.

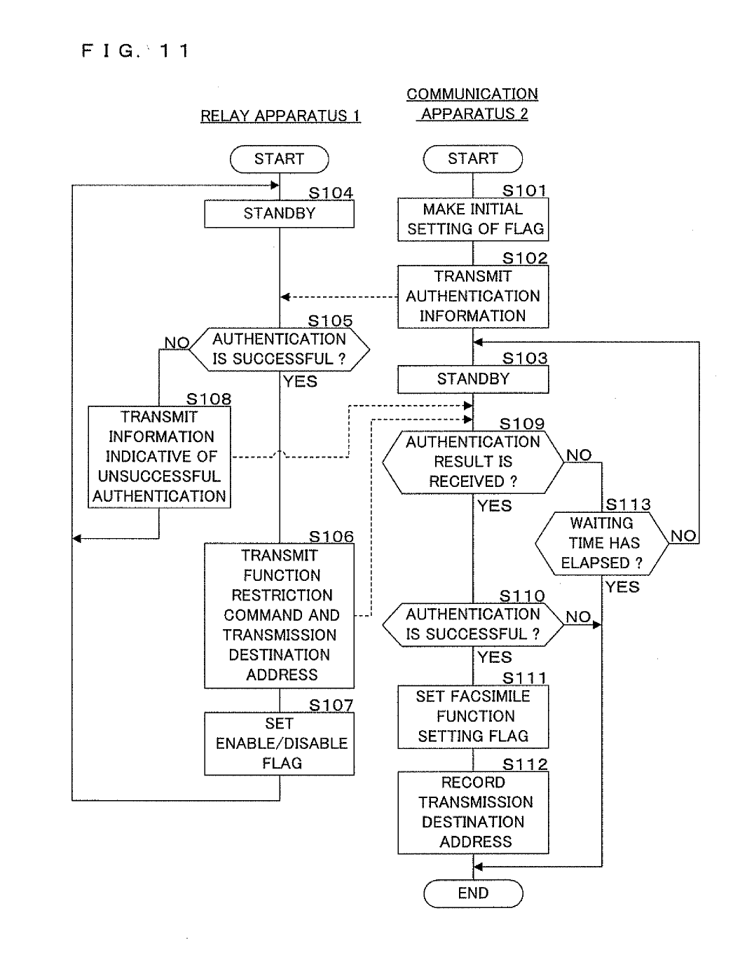

Next, processing performed by each apparatus according to Embodiment 1 of the present invention will be described. FIG. 11 is a flow chart illustrating authentication processing performed by the relay apparatus 1 and the communication apparatus 2 in the communication system according to Embodiment 1 of the present invention. At the time of startup, e.g., at the time of startup after power-on or at the time of restart after reset, the communication apparatus 2 starts authentication processing in accordance with control performed by the control unit 20. At the startup of the communication apparatus 2, the control unit 20 makes initial settings to set enable flags for facsimile transmission and facsimile reception set by facsimile function setting flags (S101). In the initial settings made in Step S101, facsimile transmission and facsimile reception of the communication apparatus 2 are both enabled.

The control unit 20 executes the authentication program 203 to perform an authentication process for log-in for establishing communication with the relay apparatus 1, so that authentication information, including the device ID and password recorded in advance, is transmitted to the relay apparatus 1 from the first communication unit 25 (S102). In other words, at the time of startup, the communication apparatus 2 makes a request to the relay apparatus 1 for establishment of communication. After the transmission of the authentication information including the device ID and password, the control unit 20 enters a standby state to wait for an authentication result (S103).

In accordance with control performed by the control unit 10, the relay apparatus 1, which is in a standby state to wait for processing (S104), receives the request for establishment of communication from the communication apparatus 2, and starts authentication processing for the communication apparatus 2. The control unit 10 receives, at the communication unit 12, the authentication information including the device ID and password, and executes an authentication process for checking the received device ID and password against those recorded in the management information retaining section 111 (S105).

Upon determination in Step S105 that the authentication is successful (S105: YES), the control unit 10 transmits a function restriction command and a facsimile server transmission destination address to the communication apparatus 2 from the communication unit 12 (S106). The function restriction command is information generated based on the details of the function restriction flags recorded in the management information retaining section 111, and serves as a command indicative of settings such as “Enabling of Facsimile Reception, and Disabling of Facsimile Transmission”. Note that the following description will be made on the assumption that the command indicates the settings of “Disabling of Facsimile Reception, and Disabling of Facsimile Transmission”. Furthermore, the facsimile server transmission destination address is information such as an IP address indicative of a facsimile server which is a transmission destination for image data to be subjected to facsimile transmission. For example, the IP address of the relay apparatus 1 is used as the facsimile server transmission destination address.

Then, the control unit 10 sets the enable/disable flag in the management information retaining section 111 to “Enable” (S107), and returns the processing to Step S104 to enter a standby state. As described above, the relay apparatus 1 executes the authentication process in Step S105 and then performs the processes of Steps S106 and S107, thus determining, as a usable apparatus, the communication apparatus 2 for which the authentication is successful, and establishing communication with the communication apparatus 2 to enable transmission and reception of image data therebetween.

Upon determination in Step S105 that the authentication is unsuccessful (S105: NO), the control unit 10 transmits information indicative of unsuccessful authentication to the communication apparatus 2 from the communication unit 12 (S108), and returns the processing to Step S104 to enter a standby state.

The control unit 20 of the communication apparatus 2 determines whether or not the authentication result is received (S109). The determination process of Step S109 is performed to determine whether or not information indicative of successful authentication or information indicative of unsuccessful authentication, which is transmitted from the relay apparatus 1, is received. Note that the function restriction command and facsimile server transmission destination address serve as the information indicative of successful authentication.

Upon determination in Step S109 that the authentication result is received (S109: YES), the control unit 20 determines whether or not the authentication is successful (S110). As mentioned above, the control unit 20 determines that the authentication is successful when the function restriction command and the facsimile server transmission destination address are received.

Upon determination in Step S110 that the authentication is successful (S110: YES), the control unit 20 sets the facsimile function setting flags based on the received function restriction command (S111), and records the facsimile server transmission destination address (S112). As a result of the setting made in Step S111, the facsimile function setting flags are set to “Disabling of Facsimile Transmission” and “Disabling of Facsimile Reception”. In Step S112, the facsimile server transmission destination address is recorded, for example, in the memory of the control unit 20 or the recording unit 24. Then, the communication apparatus 2 ends the authentication processing.

Upon determination in Step S109 that no authentication result is received (S109: NO), the control unit 20 determines whether or not a predetermined reception waiting time set in advance has elapsed (S113).

Upon determination in Step S113 that the predetermined reception waiting time set in advance has not elapsed (S113: NO), the control unit 20 returns the processing to Step S103 to enter a standby state.

Upon determination in Step S113 that the predetermined reception waiting time set in advance has elapsed (S113: YES), the control unit 20 ends the authentication processing.

Upon determination in Step S110 that the authentication is unsuccessful (S110: NO), the control unit 20 ends the authentication processing. Note that when the authentication is unsuccessful, the initial settings by which the function restriction flags indicate “Enabling of Facsimile Reception, and Enabling of Facsimile Transmission” are unchanged, and the communication apparatus 2 is allowed to execute the facsimile function without any particular restriction.

When the authentication processing is executed at the startup of the communication apparatus 2 and authentication is successful as described above, communication between the communication apparatus 2 and the relay apparatus 1 is established, and the communication apparatus 2 is placed under the management of the relay apparatus 1, thus allowing the relay apparatus 1 to restrict execution of the facsimile function of the communication apparatus 2. Note that the above-described authentication processing has been described as being performed in an automatic mode, but the present invention is not limited to this mode. Alternatively, when deemed appropriate, a manager may make access to the relay apparatus 1 and input a device ID and a password manually to perform authentication and log-in.

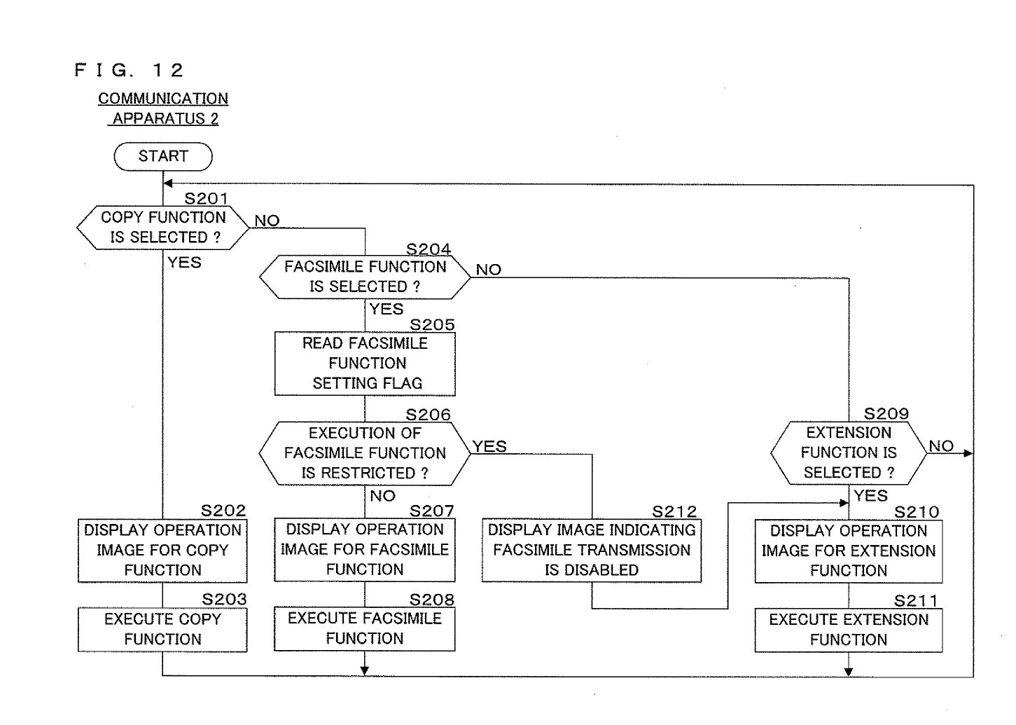

FIG. 12 is a flow chart illustrating exemplary function selection processing performed by the communication apparatus 2 in the communication system according to Embodiment 1 of the present invention. When the user tries to operate the communication apparatus 2 in a state where execution of the facsimile function is restricted, the communication apparatus 2 executes the function selection processing in accordance with control performed by the control unit 20.

The user operates the operation unit 21 of the communication apparatus 2, which is in an operation waiting state, to input function selection with the aim of displaying the image illustrated in one of FIGS. 6 to 10, for example. In accordance with control performed by the control unit 20, the communication apparatus 2, which has received via the operation unit 21 the operation performed by the user, determines whether or not the copy function is selected (S201).

Upon determination in Step S201 that the copy function is selected (S201: YES), the control unit 20 displays the operation image concerning the copy function (S202). In Step S202, the operation image illustrated in FIG. 6, for example, is displayed. Then, the control unit 20 executes the copy function based on an operation performed by the user (S203). After the execution of the copy function, the communication apparatus 2 enters an operation waiting state.

Upon determination in Step S201 that the copy function is not selected (S201: NO), the control unit 20 determines whether or not the facsimile function is selected (S204).

Upon determination in Step S204 that the facsimile function is selected (S204: YES), the control unit 20 reads the facsimile function setting flag (S205), and determines whether or not execution of the facsimile function is restricted (S206). In Step S206, when “Disabling of Facsimile Transmission” is set for the read facsimile function setting flag, the control unit 20 determines that execution of the facsimile function is restricted, and when “Enabling of Facsimile Transmission” is set for the read facsimile function setting flag, the control unit 20 determines that execution of the facsimile function is not restricted. In other words, in Step S206, the control unit 20 determines whether or not the facsimile function is restricted based on whether or not facsimile transmission is disabled.

Upon determination in Step S206 that execution of the facsimile function is not restricted, i.e., upon determination in Step S206 that facsimile transmission is enabled (S206: NO), the control unit 20 displays the operation image concerning the facsimile function (S207). In Step S207, the operation image illustrated in FIG. 7, for example, is displayed. Then, the control unit 20 executes the facsimile function based on an operation performed by the user (S208). After the execution of the facsimile function, the communication apparatus 2 enters an operation waiting state.

Upon determination in Step S204 that the facsimile function is not selected (S204: NO), the control unit 20 determines whether or not the extension function is selected (S209). Upon determination in Step S209 that the extension function is selected (S209: YES), the control unit 20 displays the operation image concerning the extension function (S210). In Step S210, the operation image illustrated in FIG. 8, for example, is displayed. Then, the control unit 20 executes the extension function based on an operation performed by the user (S211). After the execution of the extension function, the communication apparatus 2 enters an operation waiting state. One of the extension functions, executed in Step S211, is “Cloud FAX Service”, i.e., the network facsimile function.

Upon determination in Step S209 that no extension function is selected (S209: NO), the control unit 20 returns to an operating waiting state. In other words, when none of the functions is selected by the received operation, the control unit 20 determines that there has occurred an abnormality such as an operating error or a detection error. In that case, a message indicative of an abnormal state, such as “Please perform the operation again”, may be displayed.

Upon determination in Step S206 that execution of the facsimile function is restricted (S206: YES), the control unit 20 displays, on the operation unit 21, an image indicating that execution of the facsimile function is restricted because facsimile transmission is disabled (S212).

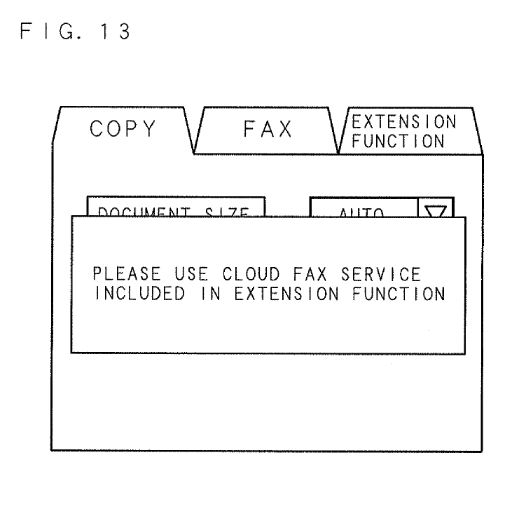

FIG. 13 is an explanatory diagram illustrating an example of an image displayed on the operation unit 21 of the communication apparatus 2 in the communication system according to Embodiment 1 of the present invention. FIG. 13 illustrates the image indicating that facsimile transmission is disabled, and the text “Please use cloud Fax service included in extension functions” is presented on the image. The control unit 20 displays the image illustrated in FIG. 13, thereby notifying the user of the fact that facsimile transmission is disabled and prohibiting reception of an operation for executing the facsimile function.

Referring again to the flow chart of FIG. 12, after Step S212, the control unit 20 advances the processing to Step S210 to execute the subsequent steps. When execution of the facsimile function is restricted as mentioned above, the control unit 20 displays an operation screen concerning an extension function after a predetermined condition has been met; for example, the control unit 20 displays an operation screen concerning an extension function after a lapse of a predetermined period of time from the display of the image illustrated in FIG. 13, or after some sort of operation performed by the user has been received. Note that the display of an operation screen for an extension function may be omitted, and an operation screen concerning the network facsimile function, illustrated in FIG. 9, may be displayed.

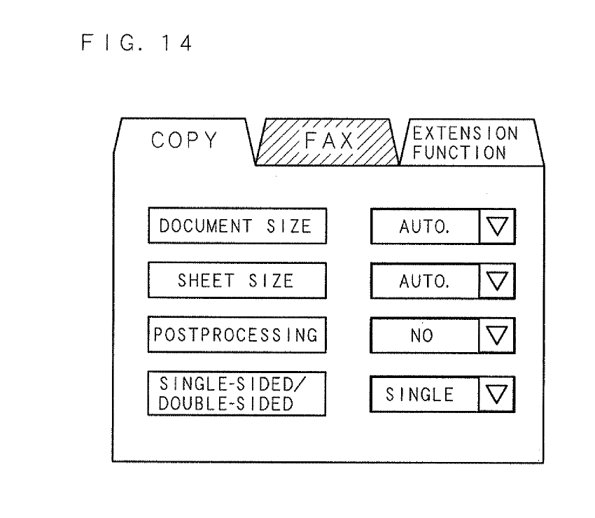

FIG. 14 is an explanatory diagram illustrating another example of an image displayed on the operation unit 21 of the communication apparatus 2 in the communication system according to Embodiment 1 of the present invention. The flow chart of FIG. 12 and the image illustrated in FIG. 13 represent a mode in which the image indicating that facsimile transmission is disabled is displayed upon selection of the facsimile function when facsimile transmission is disabled due to the restriction on execution of the facsimile function. However, the present invention is not limited to this mode, but settings may be made so that selection of the facsimile function itself will not be received. FIG. 14 illustrates an operation image displayed when such settings are made. In FIG. 14, the tab “FAX” indicative of the facsimile function is set so that the tab is presented in gray, thus allowing the user to visually recognize the tab and preventing the user from performing an operation for selecting the tab. In this case, the steps, which are to be performed when the answer in Step S204 is YES, will not be executed in the flow chart of FIG. 12.

Thus, the function selection processing is executed in the state where execution of the facsimile function is restricted. Then, the user will utilize facsimile communication by execution of the network facsimile function.

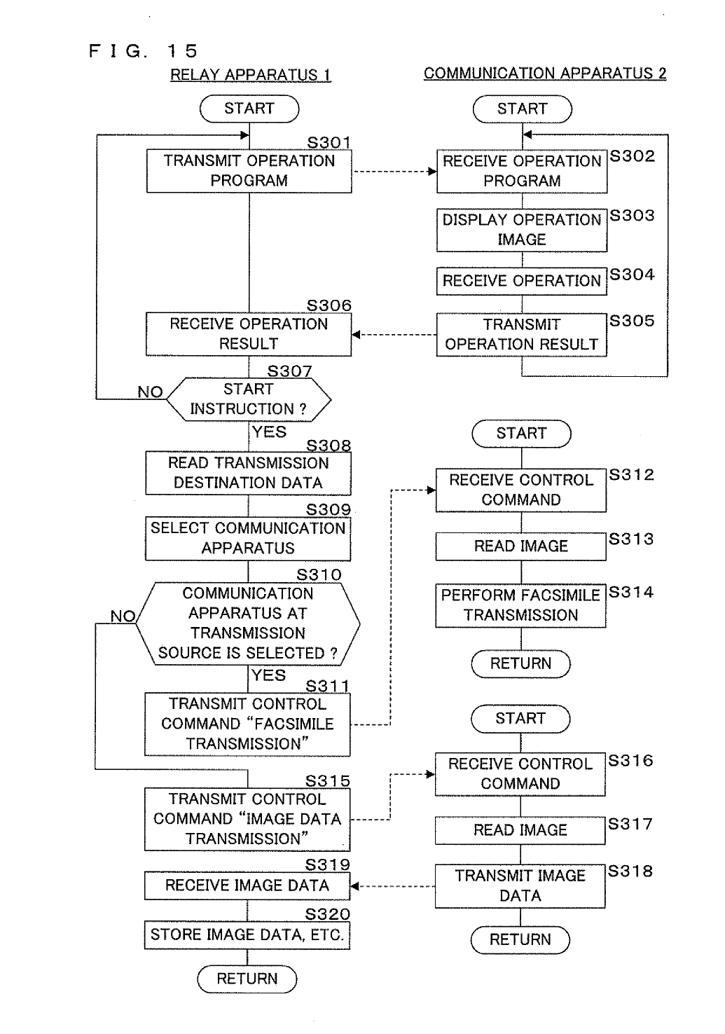

Next, processing performed by execution of the network facsimile function will be descried. FIG. 15 is a flow chart illustrating exemplary first facsimile transmission processing performed by the relay apparatus 1 and the communication apparatus 2 in the communication system according to Embodiment 1 of the present invention. The first facsimile transmission processing illustrated in FIG. 15 is processing in which the communication apparatus 2 reads an image and transmits the read image to the relay apparatus 1 or the facsimile apparatus 3 in performing facsimile communication by execution of the network facsimile function.

Upon selection of the network facsimile function, the communication apparatus 2 notifies the relay apparatus 1 of the selection of the network facsimile function. In response to the notification, the relay apparatus 1 transmits the operation program, recorded in the recording unit 11, to the communication apparatus 2 from the communication unit 12 in accordance with control performed by the control unit 10 (S301). The operation program transmitted in Step S301 is an operation program concerning an operation screen which is described in a page description language such as HTML and provided as a user interface to the communication apparatus 2.

The communication apparatus 2 receives the operation program at the first communication unit 25 in accordance with control performed by the control unit 20 (S302). The control unit 20 executes the UI program 202 and the Web browser 204, thereby displaying, on the operation unit 21, operation images based on the operation program (S303). In Step S303, the operation images illustrated in FIGS. 9 and 10 are displayed. Then, the user performs an operation while observing the operation images.

The control unit 20 executes the UI program 202 and the Web browser 204 to receive, via the operation unit 21, the operation performed by the user (S304) and to transmit a result of the received operation to the relay apparatus 1 from the first communication unit 25 (S305).

The relay apparatus 1 receives the operation result in accordance with control performed by the control unit 10 (S306). The control unit 10 determines whether or not the received operation result is an instruction for starting facsimile transmission by the network facsimile function (S307).

Upon determination in Step S307 that the received operation result is not the start instruction (S307: NO), the control unit 10 returns the processing to Step S301 to repeat the subsequent steps. The operation images have a hierarchical structure, and the relay apparatus 1 and the communication apparatus 2 repeatedly execute the processes of Steps S301 to S307; thus, the transmission start instruction, including transmission destination data indicative of a transmission destination such as a facsimile number and transmission condition data indicative of a necessary transmission condition, is provided to the relay apparatus 1 from the communication apparatus 2. The necessary transmission condition is, for example, information necessary for facsimile transmission, such as a resolution and a specified transmission time.

Upon determination in Step S307 that the received operation result is the start instruction (S307: YES), the control unit 10 reads the transmission destination data such as a facsimile number included in the start instruction (S308).

Based on the read transmission destination data, the control unit 10 selects the communication apparatus 2 which is allowed to execute facsimile transmission (S309). The communication apparatus 2 is selected in Step S309 as follows. For example, a telephone exchange number such as an area code for the facsimile number is determined, and the communication apparatus 2 located within the area of this area code is selected as a forwarding destination, thus selecting the communication apparatus 2. On the other hand, when no communication apparatus 2 is located within the area of this area code, the communication apparatus 2 for which the lowest communication fee is charged is selected as the forwarding destination.

The control unit 10 determines whether or not the selected communication apparatus 2 (hereinafter referred to as the “selected communication apparatus”) is the communication apparatus 2 operated by the user and serving as the transmission source for the start instruction (S310).

Upon determination in Step S310 that the selected communication apparatus is the communication apparatus 2 serving as the transmission source for the start instruction (S310: YES), the control unit 10 transmits a control command for executing facsimile transmission from the communication unit 12 to the communication apparatus 2 (S311). Then, the relay apparatus 1 makes a transition to a standby state.

The communication apparatus 2 receives the control command at the first communication unit 25 in accordance with control performed by the control unit 20 (S312).

In accordance with control performed by the document reading unit API 205 and the facsimile communication unit API 207 based on the control command, the control unit 20 reads, via the document reading unit 22, an image to be transmitted (S313) and performs facsimile transmission for transmitting the image to the transmission destination from the second communication unit 26 (S314). Then, the communication apparatus 2 displays information indicative of completion of the transmission, and makes a transition to a standby state.

Upon determination in Step S310 that the selected communication apparatus is different from the communication apparatus 2 serving as the transmission source for the start instruction (S310: NO), the control unit 10 transmits a control command for image data transmission from the communication unit 12 to the communication apparatus 2 (S315). Then, the relay apparatus 1 makes a transition to a standby state.

The communication apparatus 2 receives the control command at the first communication unit 25 in accordance with control performed by the control unit 20 (S316).

In accordance with control performed by the document reading unit API 205 based on the control command, the control unit 20 reads, via the document reading unit 22, an image to be transmitted (S317) and transmits image data, which is based on the read image, to the relay apparatus 1 from the first communication unit 25 (S318). Then, the communication apparatus 2 displays information indicative of completion of the processing, and makes a transition to a standby state.

The relay apparatus 1 receives the image data at the communication unit 12 in accordance with control performed by the control unit 10 (S319). Then, the control unit 10 stores, in the data storage section 112, the received image data along with the transmission destination data indicative of the transmission destination for the image data, and the transmission condition data (S320). Thus, the first facsimile transmission processing is executed.

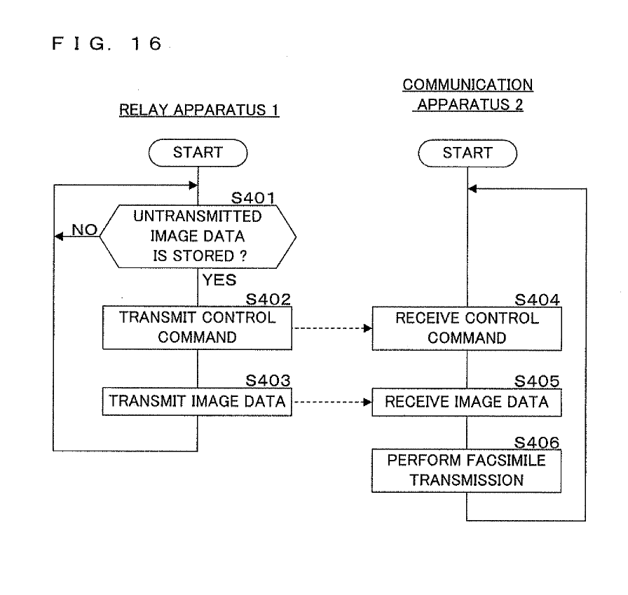

FIG. 16 is a flow chart illustrating exemplary second facsimile transmission processing performed by the relay apparatus 1 and the communication apparatus 2 in the communication system according to Embodiment 1 of the present invention. The second facsimile transmission processing, performed by the relay apparatus 1 and the communication apparatus 2 in the communication system according to the present invention, is processing in which the image data, stored in the relay apparatus 1 by the first facsimile transmission processing, is transferred to the communication apparatus 2 and facsimile transmission of the image data is performed. Note that even when the facsimile function of the communication apparatus 2 is controlled, a process for performing facsimile transmission of the transferred image data, i.e., facsimile transmission performed by the network facsimile function, is be subjected to restriction. Facsimile transmission performed by the network facsimile function is not directly carried out by the communication apparatus 2, but is carried out by controlling the facsimile communication unit API 207 of the communication apparatus 2 by the relay apparatus 1. In accordance with control performed by the control unit 10, the relay apparatus 1 executes the following processing.

The control unit 10 determines whether or not untransmitted image data, which should be subjected to facsimile transmission, is stored in the data storage section 112 (S401).

Upon determination in Step S401 that untransmitted image data is stored (S401: YES), the control unit 10 transmits a control command for controlling the facsimile communication unit API 207 to the communication apparatus 2 from the communication unit 12 (S402), and further transmits the image data to the communication apparatus 2 from the communication unit 12 (S403). The control command includes information such as a transmission destination and a resolution, which are based on transmission destination data and transmission condition data. The communication apparatus 2, serving as the transmission destination for the control command and the image data in Steps S402 and S403, is the communication apparatus 2 selected in Step S309 of the first facsimile transmission processing described with reference to FIG. 15.

Then, the control unit 10 returns the processing to Step S401 to repeat the subsequent steps. On the other hand, upon determination in Step S401 that no untransmitted image data is stored (S401: NO), the control unit 10 does not execute the processes of Steps S402 and S403 but repeatedly performs the process of Step S401.

In accordance with control performed by the control unit 20, the communication apparatus 2 selected by the relay apparatus 1 receives the control command (S404) and further receives the image data (S405) at the first communication unit 25.

Then, the facsimile communication unit API 207 is controlled based on the received control command; thus, the communication apparatus 2 performs facsimile transmission for transmitting the received image data to the facsimile apparatus 3 serving as the transmission destination via the public telephone network NW2 from the second communication unit 26 (S406). Thus, the relay apparatus 1 and the communication apparatus 2 execute the second facsimile transmission processing for performing facsimile transmission by which the image data, transferred from the relay apparatus 1, is transmitted from the communication apparatus 2 to the facsimile apparatus 3 serving as the transmission destination.

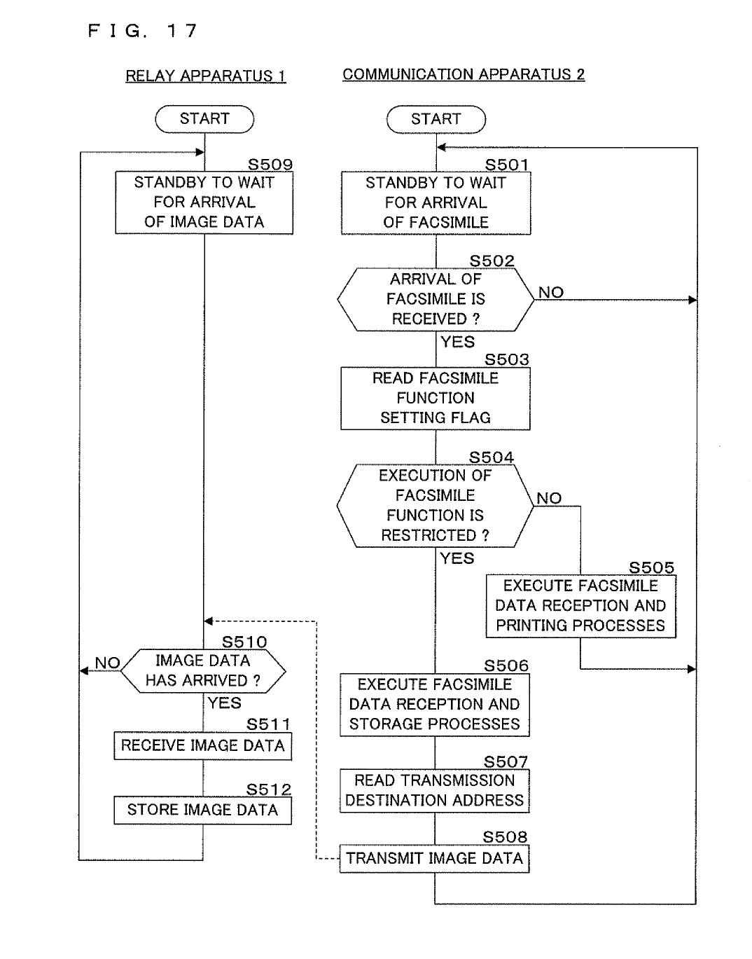

Next, processing performed at the time of reception of facsimile data will be described. FIG. 17 is a flow chart illustrating exemplary first facsimile reception processing performed by the relay apparatus 1 and the communication apparatus 2 in the communication system according to Embodiment 1 of the present invention. In accordance with control performed by the control unit 20, the communication apparatus 2 is put on standby to wait for arrival of facsimile data (S501), and determines whether or not arrival of facsimile data is received (S502).

Upon determination in Step S502 that arrival of facsimile data is received (S502: YES), the communication apparatus 2 reads the facsimile function setting flag in accordance with control performed by the control unit 20 (S503), and determines whether or not execution of the facsimile function is restricted (S504). In Step S504, the control unit 20 determines that execution of the facsimile function is restricted when “Disabling of Facsimile Reception” is set for the read facsimile function setting flag, and determines that execution of the facsimile function is not restricted when “Enabling of Facsimile Reception” is set for the read facsimile function setting flag. In other words, in Step S504, whether or not the facsimile function is restricted is determined based on whether or not facsimile reception is disabled. Note that the expression “Disabling of Facsimile Reception” used herein does not mean that facsimile reception itself is disabled, but means that a printing process performed based on received facsimile data is disabled.

Upon determination in Step S504 that execution of the facsimile function is not restricted (S504: NO), the control unit 20 executes facsimile data reception and printing processes in accordance with control performed by the facsimile communication unit API 207 and the printing unit API 206 (S505). The reception process in Step S505 is a process for receiving, at the second communication unit 26, facsimile data transmitted from a different apparatus, i.e., the facsimile apparatus 3, via the public telephone network NW2. Further, facsimile data means image data provided in compliance with a facsimile communication protocol. The printing process in Step S505 means a process in which the printing unit 23 forms an image on an image formation medium in accordance with image data based on the facsimile data. Then, the control unit 20 returns the processing to Step S501 and enters a standby state to wait for arrival of facsimile data.

Upon determination in Step S504 that execution of the facsimile function is restricted (S504: YES), the control unit 20 executes facsimile data reception and storage processes in accordance with control performed by the facsimile communication unit API 207 (S506). In Step S506, the received facsimile data is stored as image data in the memory 208 of the control unit 20, for example.

The control unit 20 reads the facsimile server transmission destination address recorded in the authentication processing (S507). From the first communication unit 25, the control unit 20 transmits the image data, which is based on the stored facsimile data, to the relay apparatus 1 indicated by the read facsimile server transmission destination address (S508). Then, the control unit 20 returns the processing to Step S501 and enters a standby state to wait for arrival of facsimile data.

Note that upon determination in Step S502 that arrival of facsimile data is not received (S502: NO), the control unit 20 returns the processing to Step S501 and enters a standby state to wait for arrival of facsimile data.

In accordance with control performed by the control unit 10, the relay apparatus 1 enters a standby state to wait for arrival of the image data that is based on the facsimile data (S509), and determines whether or not the image data has arrived (S510).

Upon determination in Step S510 that the image data has arrived (S510: YES), the control unit 10 receives the image data at the communication unit 12 (S511), and stores the received image data in the data storage section 112 (S512). Then, the control unit 10 is returned to the standby state of Step S509 to repeat the subsequent steps.

Note that upon determination in Step S510 that the image data has not arrived (S510: NO), the control unit 10 returns the processing to Step S509 and enters a standby state to wait for arrival of image data. Thus, the first facsimile reception processing is executed.

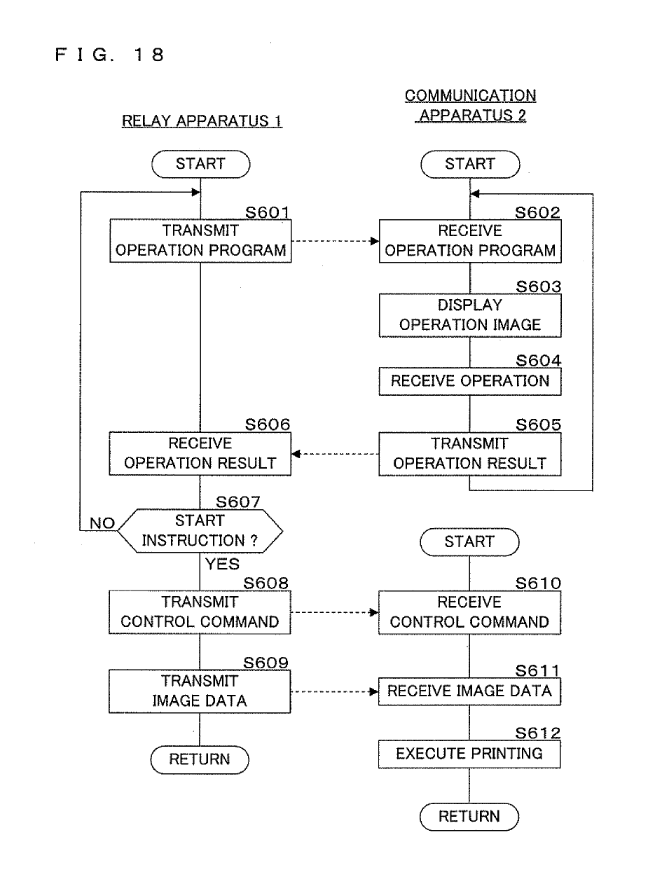

FIG. 18 is a flow chart illustrating exemplary second facsimile reception processing performed by the relay apparatus 1 and the communication apparatus 2 in the communication system according to Embodiment 1 of the present invention. The second facsimile reception processing is processing in which the image data, received as facsimile data and stored in the relay apparatus 1, is printed by the appropriately selected communication apparatus 2 in accordance with an operation performed by the user or automatic processing performed by the relay apparatus 1.

In accordance with control performed by the control unit 10, the relay apparatus 1 transmits the operation program, recorded in the recording unit 11, to the communication apparatus 2 from the communication unit 12 (S601). The operation program transmitted in Step S601 is an operation program concerning an operation screen which is described in a page description language such as HTML and provided as a user interface to the communication apparatus 2.

The communication apparatus 2 receives the operation program at the first communication unit 25 in accordance with control performed by the control unit 20 (S602). The control unit 20 executes the UI program 202 and the Web browser 204, thereby displaying, on the operation unit 21, operation images based on the operation program (S603). Then, the user performs an operation while observing the operation images.

The control unit 20 executes the UI program 202 and the Web browser 204 to receive, via the operation unit 21, the operation performed by the user (S604) and to transmit a result of the received operation to the relay apparatus 1 from the first communication unit 25 (S605).

The relay apparatus 1 receives the operation result in accordance with control performed by the control unit 10 (S606). The control unit 10 determines whether or not the received operation result is an instruction for starting printing of the image data based on the facsimile data (S607).

Upon determination in Step S607 that the received operation result is not the start instruction (S607: NO), the control unit 10 returns the processing to Step S601 to repeat the subsequent steps. The operation images have a hierarchical structure, and the relay apparatus 1 and the communication apparatus 2 repeatedly execute the processes of Steps S601 to S607; thus, the user performs various operations, including issuance of instructions for content confirmation, selection, and printing condition of the image data.

Upon determination in Step S607 that the received operation result is the start instruction (S607: YES), the control unit 10 transmits a control command for execution of printing of the image data to the communication apparatus 2 from the communication unit 12 (S608).

Moreover, the control unit 10 reads, from the data storage section 112, the image data selected by the start instruction, and transmits the read image data to the communication apparatus 2 from the communication unit 12 (S609). Then, the relay apparatus 1 is returned to a standby state.

In accordance with control performed by the control unit 20, the communication apparatus 2 receives the control command (S610) and further receives the image data (S611) at the first communication unit 25.

In accordance with control performed by the printing unit API 206 based on the received control command, the control unit 20 allows the printing unit 23 to form, on an image formation medium, an image based on the received image data, thereby executing the printing process (S612). Thus, the second facsimile reception processing is executed.

As described above, when communication is established between the relay apparatus 1 and the communication apparatus 2 in the communication system according to the present invention, execution of the facsimile function of the communication apparatus 2 other than the network facsimile function executed under the control of the relay apparatus 1 is restricted. As a result, the relay apparatus 1 prevents the communication apparatus 2 from executing the facsimile function locally, and performs management such as reduction of communication fee and control of transmission/reception time, thus making it possible to create an efficient system as a whole.

### Embodiment 2

Embodiment 2 of the present invention provides a mode in which when authentication is unsuccessful in establishing communication between the relay apparatus and communication apparatus at the time of startup thereof in Embodiment 1, facsimile data, the arrival of which is subsequently received, is received, stored and printed, thereby preventing failure of confirmation of the received data. Note that in the following description, elements similar to those of Embodiment 1 are identified by reference characters similar to those used in Embodiment 1, and therefore, description thereof will be omitted on the assumption that reference may be made to Embodiment 1.

Configuration examples of the communication system, relay apparatus 1 and communication apparatus 2 according to Embodiment 2 are similar to those in Embodiment 1, and therefore, description thereof will be omitted on the assumption that reference may be made to Embodiment 1. However, the facsimile function setting flags, recorded in the memory 208 included in the communication apparatus 2, include a flag indicative of “Reception, Storage and Printing of Facsimile Data upon Arrival” in addition to the items described in Embodiment 1 with reference to FIG. 5.

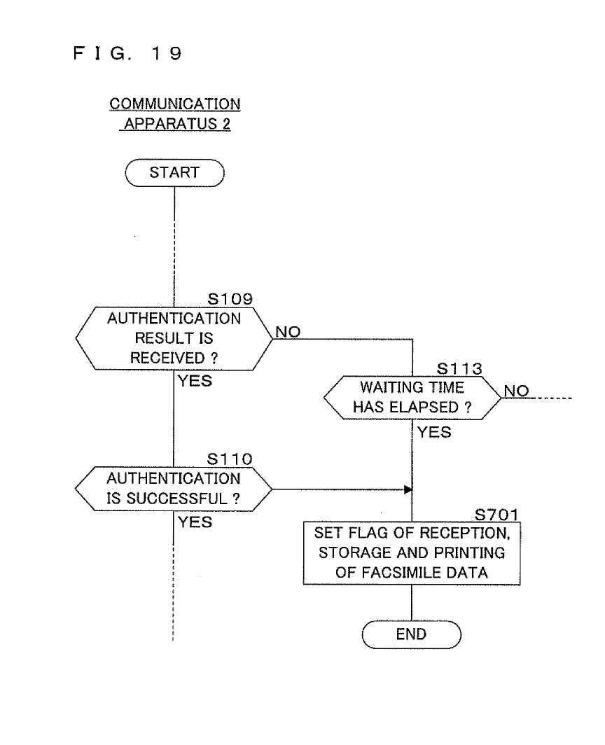

Next, processing performed by each apparatus according to Embodiment 2 of the present invention will be described. FIG. 19 is a flow chart illustrating authentication processing performed by the communication apparatus 2 in the communication system according to Embodiment 2 of the present invention. Processes performed upon successful authentication in the authentication processing according to Embodiment 2 are similar to those of Embodiment 1 illustrated in FIG. 11, and therefore, description thereof will be omitted on the assumption that reference may be made to FIG. 11 and its description in Embodiment 1.

In the process corresponding to Step S110 of the authentication processing according to Embodiment 1, when the communication apparatus 2 determines that authentication is unsuccessful in accordance with control performed by the control unit 20 (S110: NO), the control unit 20 changes the setting of the facsimile function setting flag to “Reception, Storage and Printing of Facsimile Data upon Arrival” (S701). In other words, the above-mentioned facsimile function setting flag is set to be ON. Then, the control unit 20 ends the authentication processing.

On the other hand, in the process corresponding to Step S113 of the authentication processing according to Embodiment 1, upon determination that no authentication result is received (S109: NO), and upon determination that a predetermined reception waiting time set in advance has elapsed (S113: YES), the control unit 20 advances the processing to Step S701.

Thus, upon unsuccessful authentication in the authentication processing according to Embodiment 2, the process for changing the setting of the facsimile function setting flag to “Reception, Storage and Printing of Facsimile Data upon Arrival” is executed instead of simply maintaining the initial setting of the facsimile function setting flag.

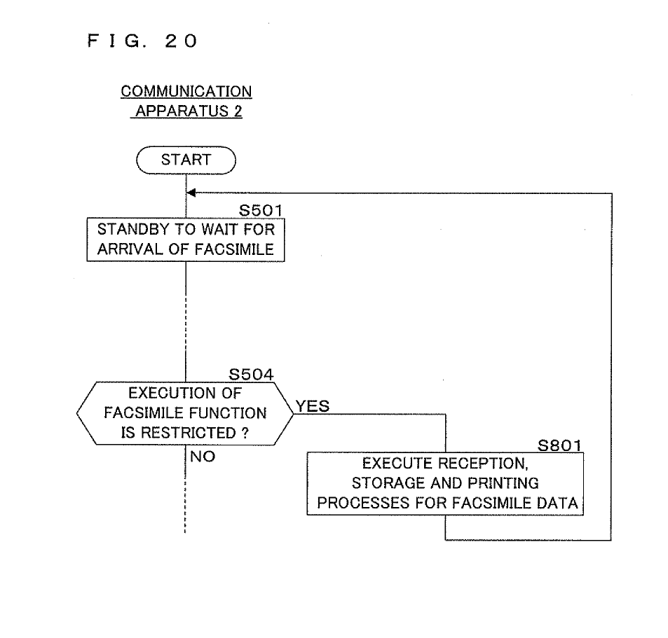

FIG. 20 is a flow chart illustrating exemplary first facsimile reception processing performed by the communication apparatus 2 in the communication system according to Embodiment 2 of the present invention. In Embodiment 2, the first facsimile reception processing is executed based on the fact that “Reception, Storage and Printing of Facsimile Data upon Arrival” is set in the authentication processing. Note that processes performed when execution of the facsimile function is not restricted in the first facsimile reception processing according to Embodiment 2 are similar to those of Embodiment 1 illustrated in FIG. 17, and therefore, description thereof will be omitted on the assumption that reference may be made to FIG. 17 and its description in Embodiment 1.

In the process corresponding to Step S504 of the first facsimile reception processing according to Embodiment 1, upon determination by the control unit 20 of the communication apparatus 2 that execution of the facsimile function is restricted (S504: YES), the control unit 20 executes reception, storage and printing processes for facsimile data (S801). The reception process in Step S801 means a process for receiving, at the second communication unit 26, facsimile data transmitted from a different apparatus, i.e., the facsimile apparatus 3, via the public telephone network NW2. The storage process in Step S801 means a process for storing the received facsimile data in the memory 208. The printing process in Step S801 means a process for allowing the printing unit 23 to form, on an image formation medium, an image in accordance with image data based on the facsimile data.

Then, after the reception, storage and printing processes in Step S801 have been executed in accordance with control performed by the control unit 20, the communication apparatus 2 returns the processing to Step S501 and enters a standby state to wait for arrival of facsimile data. Thus, the first facsimile reception processing according to Embodiment 2 is executed.

As described above, in Embodiment 2, the communication apparatus 2 executes not only the process for printing the received facsimile data but also the process for storing the received facsimile data in the communication apparatus 2 in the first facsimile reception processing when the communication apparatus 2 is unable to establish connection with the relay apparatus 1 in the authentication processing. The stored facsimile data can be transmitted to the relay apparatus 1 when the next connection is established. Thus, in a case where the connection between the relay apparatus 1 and the communication apparatus 2 cannot be established, the received facsimile data is not only printed but also stored; hence, for example, even when a communication error has occurred, it is possible to prevent occurrence of a defective condition in which the received data cannot be confirmed at all.

Note that processes other than the above-described processes illustrated in Embodiment 2 are similar to those of Embodiment 1.

### Embodiment 3

Embodiment 3 of the present invention provides a mode in which even when the user selects the facsimile function in selecting the function of the communication apparatus in Embodiment 1, an operation image that emulates the operation image concerning the facsimile function is displayed to execute an extension function. Note that in the following description, elements similar to those of Embodiment 1 are identified by reference characters similar to those used in Embodiment 1, and therefore, description thereof will be omitted on the assumption that reference may be made to Embodiment 1.

Configuration examples of the communication system, relay apparatus 1 and communication apparatus 2 according to Embodiment 3 are similar to those of Embodiment 1, and therefore, description thereof will be omitted on the assumption that reference may be made to Embodiment 1.

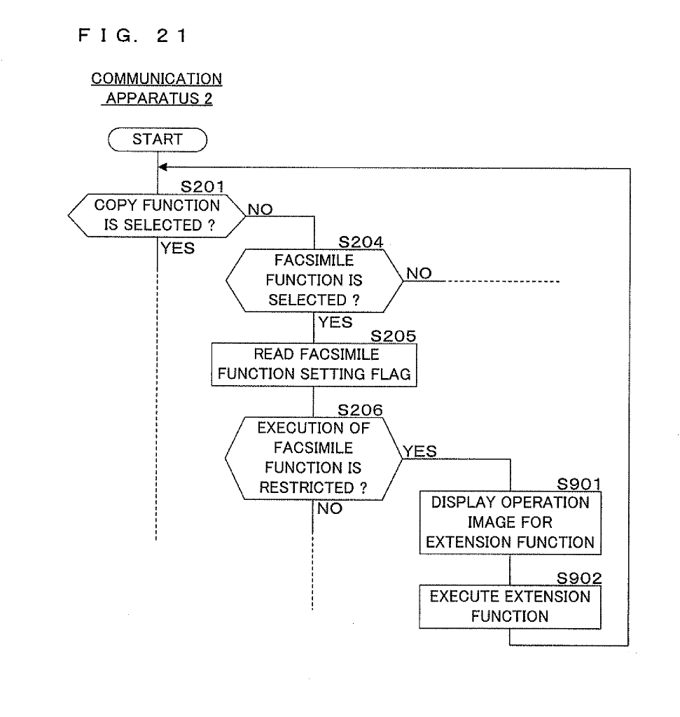

Next, processing performed by each apparatus according to Embodiment 3 will be described. FIG. 21 is a flow chart illustrating exemplary function selection processing performed by the communication apparatus 2 in the communication system according to Embodiment 3 of the present invention. Processes performed when the function other than the facsimile function is selected in the function selection processing according to Embodiment 3 are similar to those of Embodiment 1 illustrated in FIG. 12, and therefore, description thereof will be omitted on the assumption that reference may be made to FIG. 12 and its description in Embodiment 1.

In the process corresponding to Step S206 of the function selection processing according to Embodiment 1, upon determination by the communication apparatus 2 that execution of the facsimile function is restricted in accordance with control performed by the control unit 20 (S206: YES), the control unit 20 displays an operation image concerning an extension function (S901). The operation image displayed in Step S901 is an image that emulates the operation image concerning the facsimile function, and the operation image recorded in advance in the communication apparatus 2 is displayed as the operation image concerning the extension function in Step S901. Specifically, the image such as one illustrated in FIG. 7 is displayed as the operation image concerning the extension function (i.e., the network facsimile function in this embodiment). Note that when the operation image is displayed in Step S901, the communication apparatus 2 notifies the relay apparatus 1 about execution of the extension function as an alternative to the facsimile function, and displays the operation image based on an instruction provided from the relay apparatus 1. Thus, even when the extension function is executed, the operation image substantially similar to one concerning the facsimile function is provided to the user who has selected the facsimile function, thus enabling an improvement in the user's convenience.

Then, the control unit 20 executes the extension function based on an operation performed by the user (S902). After the extension function has been executed, the communication apparatus 2 enters an operation waiting state.

Note that processes performed upon determination that execution of the facsimile function is not restricted are similar to those of Embodiment 1 illustrated in FIG. 12, and therefore, description thereof will be omitted on the assumption that reference may be made to FIG. 12 and its description in Embodiment 1.

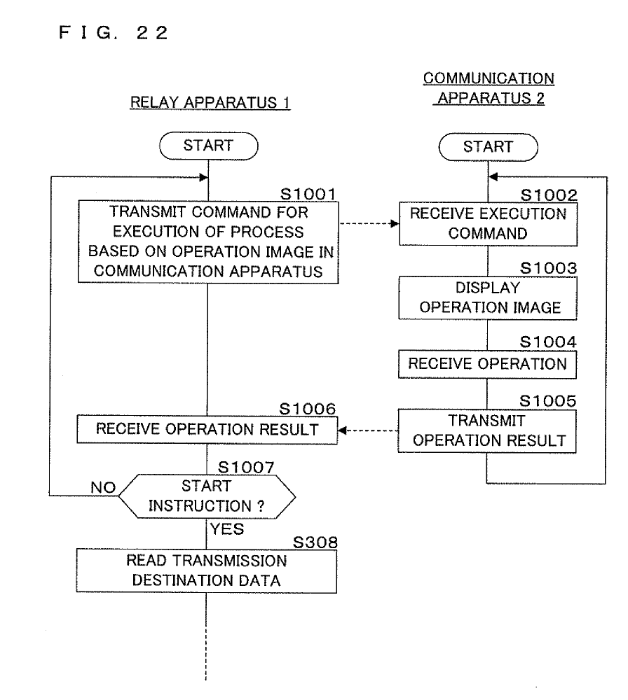

FIG. 22 is a flow chart illustrating exemplary third facsimile transmission processing performed by the relay apparatus 1 and the communication apparatus 2 in the communication system according to Embodiment 3 of the present invention. The facsimile transmission processing illustrated in FIG. 22 means transmission processing by the network facsimile function performed as the extension function when the operation image concerning the extension function, which emulates the operation image concerning the facsimile function, is presented to the user who has selected the facsimile function.

When the network facsimile function is provided in response to selection of the facsimile function, the communication apparatus 2 notifies the relay apparatus 1 about execution of the network facsimile function as an alternative to the facsimile function. In response to the notification, the relay apparatus 1 transmits a command for execution of a process, which is to be performed based on the operation image recorded in the communication apparatus 2, to the communication apparatus 2 from the communication unit 12 in accordance with control performed by the control unit 10 (S1001). In Embodiment 3, no operation program is transmitted to the communication apparatus 2 from the relay apparatus 1 when the network facsimile function is executed instead of the facsimile function.

The communication apparatus 2 receives the execution command at the first communication unit 25 in accordance with control performed by the control unit 20 (S1002), and displays, in accordance with the command, the operation image for the network facsimile function recorded in advance (S1003). The operation image displayed in Step S1003 is an image that emulates the operation image concerning the facsimile function as mentioned above. Then, the user performs an operation while observing the operation image.

The control unit 20 receives, via the operation unit 21, the operation performed by the user (S1004), and transmits a result of the received operation to the relay apparatus 1 from the first communication unit 25 (S1005).

In accordance with control performed by the control unit 10, the relay apparatus 1 receives the operation result (S1006), and the control unit 10 determines whether or not the received operation result is an instruction for start of facsimile transmission performed by the network facsimile function (S1007).

Upon determination in Step S1007 that the received operation result is not the start instruction (S1007: NO), the control unit 10 returns the processing to Step S1001 to repeat the subsequent processes with the aim of displaying the next operation image. Note that since the hierarchical structure of the operation images is recorded in the communication apparatus 2, a hierarchical image display process is executed within the communication apparatus 2, and the relay apparatus 1 may be put on standby until reception of the start instruction. Furthermore, in that case, the communication apparatus 2 may record all operations performed by the user, and may transmit the recorded data to the relay apparatus 1 collectively when the relay apparatus 1 has received input of the start instruction.

Upon determination in Step S1007 that the received operation result is the start instruction (S1007: YES), the control unit 10 executes a process concerning facsimile transmission, such as reading of transmission destination data.

Processes performed after determination that the received operation result is the start instruction in the third facsimile transmission processing according to Embodiment 3 are similar to those performed in Step S308 and the subsequent steps of the first facsimile transmission processing illustrated in FIG. 15 in Embodiment 1. Therefore, description of the similar processes will be omitted on the assumption that reference may be made to FIG. 15 and its description in Embodiment 1. Thus, the third facsimile transmission processing according to Embodiment 3 is executed.

As described above, in Embodiment 3, the operation image that emulates the operation image for execution of the facsimile function is displayed even when the facsimile function is restricted and the network facsimile function is forcedly executed. As a result, the user is allowed to use the extension function without being aware that the extension function is executed, thus enabling an improvement in the user's convenience.

Note that processes other than the above-described processes illustrated in Embodiment 3 are similar to those of Embodiment 1.

Although the description has been centered on the network facsimile function in Embodiments 1 to 3, other common element(s) and function(s) may be added to the communication system according to the present invention. For example, various terminal devices such as a personal computer, a mobile phone and a smartphone may be connected with the relay apparatus or communication apparatus directly or indirectly via the closed communication network, thereby enabling execution of various processes.

In other words, Embodiments 1 and 3 merely illustrate part of innumerable modes of the present invention. Constituent requirements for various systems, apparatuses, means, processes, condition settings, etc. may be designed appropriately in accordance with object, usage, etc.

For example, control performed on the facsimile function of the communication apparatus by the relay apparatus may be appropriately set. For instance, settings may be appropriately made so that when facsimile data has arrived, only one page may be printed by way of an index thereof. Moreover, the present invention may be developed in various modes; for example, when facsimile data has arrived, control may be performed so that the facsimile data is transferred to a different apparatus automatically.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A communication system comprising:
a plurality of communication apparatuses each having a facsimile function; and
a relay apparatus connected to the communication apparatuses via a communication network different from a telephone network used for facsimile communication,
wherein the relay apparatus receives, from one of the communication apparatuses, image data and transmission destination data indicative of a transmission destination for the image data, and transfers the received image data and transmission destination data to a selected communication apparatus based on a predetermined condition,
wherein the communication apparatus performs facsimile transmission for transmitting the transferred image data to the transmission destination indicated by the transmission destination data, and
wherein the relay apparatus comprises a restricting unit for allowing the communication apparatus, which has established communication with the relay apparatus to enable transmission and reception of image data therebetween, to restrict execution of the facsimile function other than facsimile transmission of the transferred image data.

2. The communication system according to claim 1,
wherein the restriction imposed by the restricting unit is disabling of facsimile transmission performed by the communication apparatus.

3. The communication system according to claim 1,
wherein the communication apparatus comprises a request unit for making a request to the relay apparatus for establishment of communication at startup, and
wherein the relay apparatus comprises: an authentication unit for executing authentication processing for the communication apparatus that has made the request; and an establishing unit for establishing communication with the communication apparatus, for which authentication is successful, to enable transmission and reception of image data and transmission destination data.

4. A relay apparatus for transferring, upon reception of image data and transmission destination data indicative of a transmission destination for the image data via a communication network, the image data and the transmission destination data to a different apparatus having a facsimile function via the communication network, in order to perform facsimile transmission for transmitting the image data to the transmission destination via a telephone network different from the communication network,
wherein the relay apparatus comprises a restricting unit for allowing the different apparatus, which has established communication with the relay apparatus to enable transmission and reception of image data therebetween, to restrict execution of the facsimile function other than facsimile transmission of the transferred image data.

5. A communication apparatus that has a facsimile function and communicates with a different apparatus via a communication network different from a telephone network through which facsimile communication is performed,
wherein the communication apparatus comprises:
a transmission unit for transmitting, to the different apparatus, image data to be subjected to facsimile transmission and transmission destination data indicative of a transmission destination for the image data;
a transfer facsimile unit for performing, upon reception of image data and transmission destination data from the different apparatus, facsimile transmission for transmitting the received image data to a transmission destination indicated by the transmission destination data; and
a restricting unit for restricting, upon reception of a command for restricting execution of the facsimile function from the different apparatus, execution of the facsimile function other than facsimile transmission performed by the transfer facsimile unit.

6. A non-transitory computer-readable recording medium storing a computer program to cause a computer to transfer, upon reception of image data and transmission destination data indicative of a transmission destination for the image data via a communication network, the image data and the transmission destination data to a different apparatus having a facsimile function via the communication network, in order to perform facsimile transmission for transmitting the image data to the transmission destination via a telephone network different from the communication network,
wherein the computer program comprises the step of causing the computer to allow the different apparatus, which has established communication with the computer to enable transmission and reception of image data therebetween, to restrict execution of the facsimile function other than facsimile transmission of the transferred image data.
